(19) United States
(12) Patent Application Publication
(10) Pub. No.: US 2002/0082900 A1
(43) Pub. Date: Jun. 27, 2002

(54) Method and system for collecting market research and user trend data via the internet and dispensing rebate certificates

(76) Inventor: Alan D. Johnson, Morristown, NJ (US)

Correspondence Address: Mathews, Collins, Shepherd & Gould, Suite 306, 100 Thanet Circle, Princeton, NJ, 08540, US

(21) Appl. No.: 09/748,950

(22) Filed: Dec. 27, 2000

(51) Int. Cl. G06F 17/60

(52) U.S. Cl. 705/10

(57) ABSTRACT

The present invention relates to a method and centralized system established over the Internet for automatically generating information directed to products one or more suppliers in response to user request of criteria and collecting information of market research and user trend data directed to demographic information of the users of the system and user request criteria via the Internet. The market research and user trend data can be forwarded to suppliers registered with the system and matching the users request criteria. The system also provides for generating rebate certificates directed to products requested by the user, as marketing incentives. In particular, the method and system of the present invention can be used for automatically generating a selection of solvent products in response to user input criteria of characteristics of the solvents.

### BACKGROUND OF THE INVENTION

1. Field of the Invention

The present invention relates to a method and centralized system for automated generation of information directed to products of one or more suppliers in response to user request criteria, collection of market trend data directed to users of the system and distribution of rebate certificates to the users as marketing incentives, through real time database creation and analysis over the Internet.

2. Description of the Related Art

Conventionally, a user receives information directed to a particular product by contacting a sales or technical representative of the supplier of the product. For example, users interested in purchasing chemical solvent products may contact several sales representatives of different solvent manufacturers to obtain performance comparison pricing information. Accordingly, if the user was interested in evaluating different suppliers of products, the user would need to contact multiple representatives each representing a different supplier. In this scenario, marketing data such as information related to demographics of the users and information related to preferences of the users is retained, if at all, at each individual supplier representative.

The use of and distribution of product samples is a common tool utilized by manufacturers in their marketing efforts. The distribution of samples has the disadvantage that it is difficult to limit delivery of samples to bona fide prospective purchasers. U.S. Pat. No. 6,021,362 describes an apparatus for automated distribution of samples in a retail environment to individuals determined to be eligible to receive such items. A data entry terminal at a point of sale scans UPC codes for identifying purchased products. The retailer's point of sale equipment includes pre-established criteria, which identifies each qualifier for which a given sample is dispersed. For example the pre-established criteria can include identification of the purchaser of certain quantities of particular products or particular brands and products. A data processor can record information related to the transaction such as each product purchased by a given customer and identity of the customer.

It is desirable to provide a centralized system for providing information of several suppliers to a user over the Internet in order to satisfy a user project, collecting market trend data and issuing rebate certificates.

### SUMMARY OF THE INVENTION

The present invention relates to a method and centralized system established over the Internet for automatically generating information directed to products of one or more suppliers in response to user request criteria, and collecting information of market research and user trend data directed to demographic information of the users of the system and matching the user request criteria. The market research and user trend data can be forwarded to suppliers registered with the system and the users request criteria. The system also provides for generating rebate certificates directed to products requested by the user, as marketing incentives.

In particular, the method and system of the present invention can be used for automatically generating a selection of solvent products in response to user input criteria of characteristics of the application requiring a solvent. The user's selection of a particular solvent can be forwarded to the suppliers of the particular solvent as a sales lead. Market research and user trend data, such as information directed to solvents selected or excluded by users, is forwarded to the registered suppliers to allow the suppliers to track customer preferences, thereby enhancing information used in supplier business and marketing decisions. Rebate certificates, directed to the particular solvent can be redeemed as an incentive to purchase solvent products from the registered suppliers. The system generated rebate certificates reduce the costs of acquiring new customers for the supplier.

The present invention provides a system for collecting substantially real-time information regarding preferences, biases, usage, and market trend information from a large number of users of various products and services; the incentive to provide such information being the use of low, or no-cost software accessible over the Internet as an aid to the user in designing products and services for the users'unique needs.

### BRIEF DESCRIPTION OF THE DRAWINGS

FIG. 1 is a schematic diagram of a system for product information generation, market research and user trend data collection and rebate certificate distribution.

FIG. 2 is a flow diagram of a method for user registration and user input in a solvent selection process.

FIG. 3 is a schematic diagram of a user online registration form.

FIG. 4 is a flow diagram of a method for managing user output processes.

FIG. 5 is a flow diagram of a method for supplier registration and receipt of market research and user trend data.

FIG. 6 is a schematic diagram of a supplier online registration form.

FIG. 7 is a flow diagram of a method for rewarding rebate certificates.

FIG. 8 is a flow diagram of a method for rewarding a rebate certificate after a literature request is performed and processing the literature request.

FIG. 9 is a flow diagram of a method for rewarding a rebate certificate after a sample request is performed and filling the sample request.

FIG. 10 is a flow diagram of a method for rewarding a rebate certificate after a request for a quote is performed.

FIG. 11 is a flow diagram of a method for negotiation and redemption of a rebate certificate.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

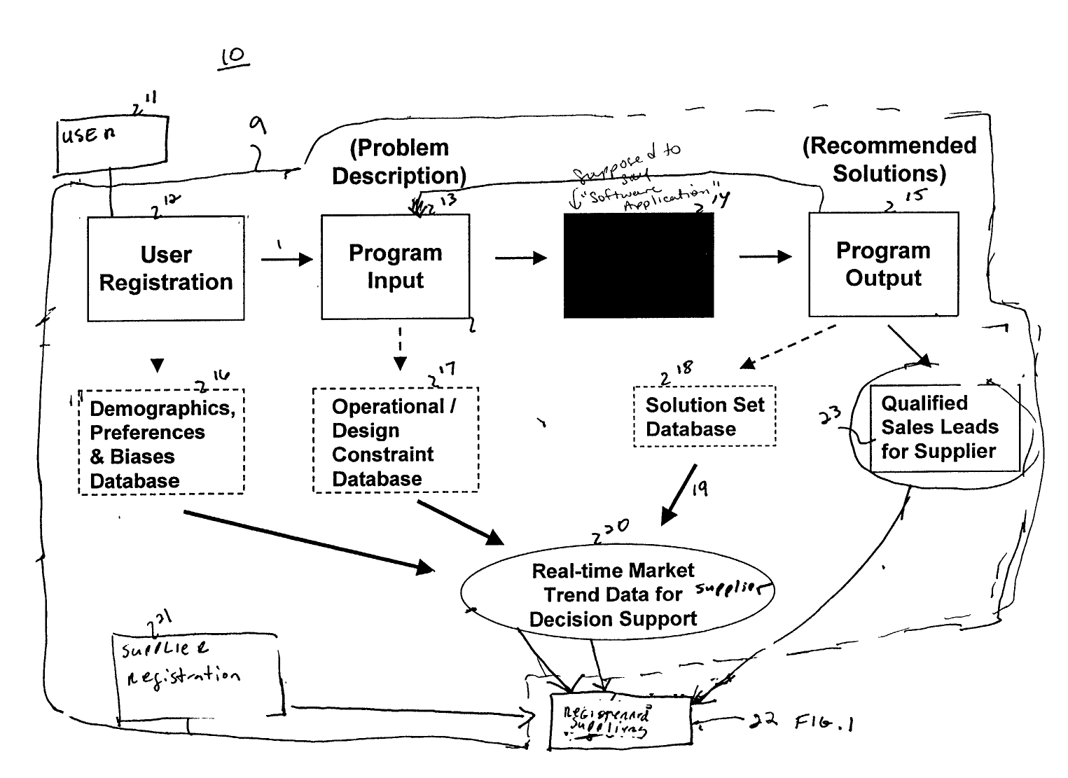

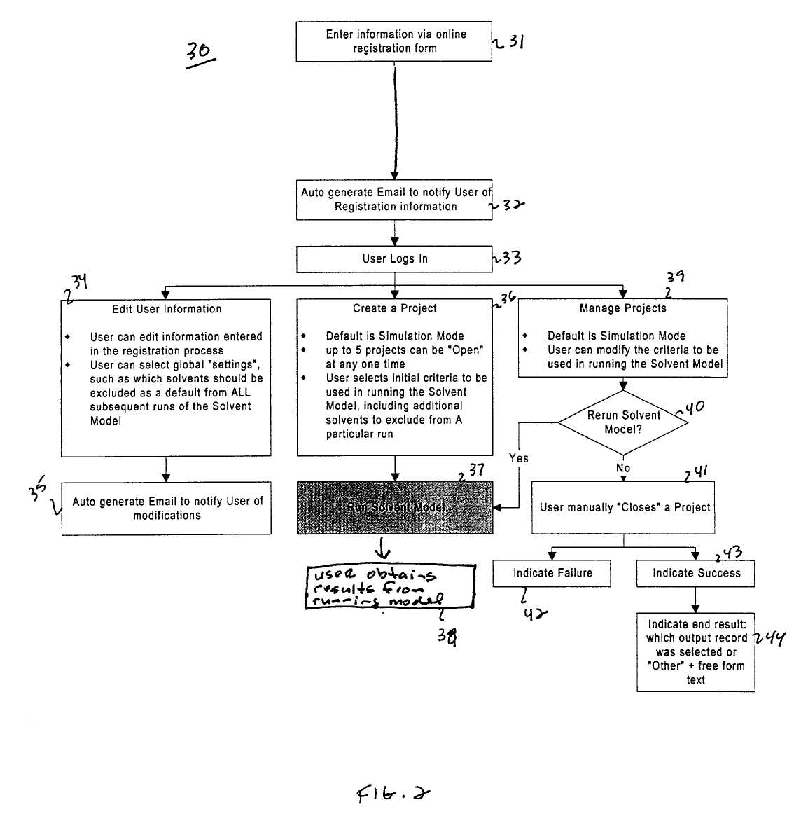

FIG. 1 is a schematic diagram of a product information generation, market research and user trend data collection and rebate certificate distribution system 10. User 11 interacts with user registration module 12. For example, user 11 can interact with user registration module 12 by contacting host 9 over the Internet. User registration module 12 performs user registration for obtaining information about user 11. For example, user registration module 12 can use an online registration form, which can be completed by user 11 or can scan a completed user hard copy registration form. In one embodiment, templates of questions to be completed online by user 11 can be determined from one or more Web pages.

Project input 13 is determined by user 11 for a project. Examples of project input 13 include requests for input related to chemical products, electronics, automotive and transportation, aerospace, building and construction, architecture, consumer product information, medical and pharmaceutical, and farming and agricultural products. Other examples of project input 13 include requests for information related to products such as chemical solvents, absorbents, additives, adhesives, aerosols, biocides, catalysts, ceramics, coatings, cosmetics, disinfectants, fabrics, fibers, flame retardants, flavors, formulations, fragrances, gases, heat transfer fluids, industrial gases, inks, insulations, lubricants, metal finishings, metals, nutraceuticals, papers, pesticides, pigments, plasticizers, plastic additives, pulps, papers, resins, sealants, surfactants, textiles, toiletries, vitamins, waste disposals and waxes that would be useful for the user's project. Other suitable examples of project input 13 can also include processing parameters such as temperatures, pressures, density, vapor pressure, evaporation rate, boiling point, and flash point.

Project software module 14 determines from project input 13 a solution to the project as program output 15. For example, software module 14 can determine a best match of solubility characteristics of a target solvent or solvent blend with project input 13 to provide project output 15 of a list of solvent and solvent blends. A solvent match can be determined, for example, by using parameter theory as described by Barton in “The Handbook of Solubility Parameters and Other Cohesion Parameters, (CRC Press). Program output 15 is forwarded to user 11.

Market research and user trend data is collected automatically during utilization of system 10. User registration data determined by registration module 12 is entered into demographics, preferences and biases database 16. Data collected in database 16 is forwarded to market trend data collection module 20. Project input 13 is entered in operational and design constraint database 17. Data collected in database 17 is forwarded to market trend data collection module 20. Project output 15 is collected in project solution set database 18. Project solution set database 18 can analyze program output to collect particular information such as the number of times that a product is recommended and the month/year that the product is recommended. Data from project solution set database 18 is forwarded to market trend data collection module 20.

Supplier registration module 21 performs supplier registration with system 10. For example, supplier registration module 21 can use an online registration form, which is completed by the supplier or can scan a completed supplier hard copy registration form. Registered suppliers 22 have access to or are forwarded information from market trend data collection module 20.

Sales lead data for suppliers 23 is determined from project output 15. Sales lead data for suppliers 23 can be forwarded to registered suppliers 22. Rebate certificate module 24 generates rebates from program output 15. Rebate certificates can be redeemed at registered supplier 22, as described below.

User 11 and supplier 22 can include a standard personal computer (“pc”) or other device possessing sufficient processing and memory for establishing a connection to the Internet. Preferably, user 11 also includes a user input device display unit and a printer for printing rebate certificates if necessary.

Host 9 can include a computer comprising a standard personal computer (pc), including a central processing unit (cpu) for carrying out program instructions, a storage medium (i.e. hard disk, cdrom) for storing program instruction and database information, a user input device, such as a keyboard and at least one output device such as a display or printer. Those skilled in the art will appreciate that the system can be developed in a variety of computers with a variety of programming languages.

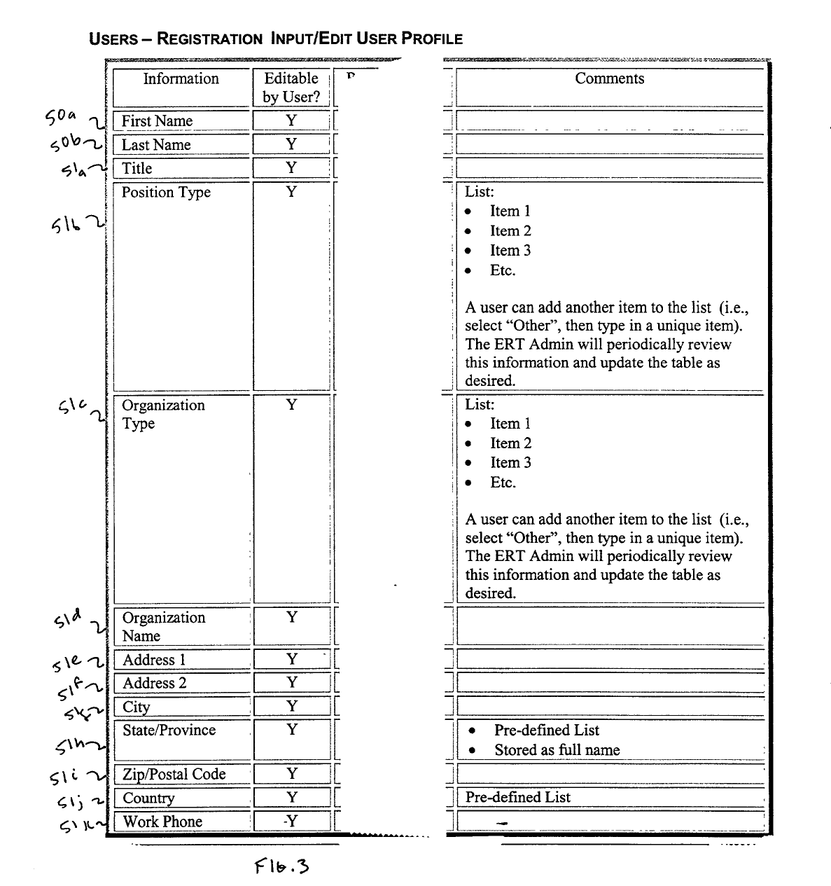

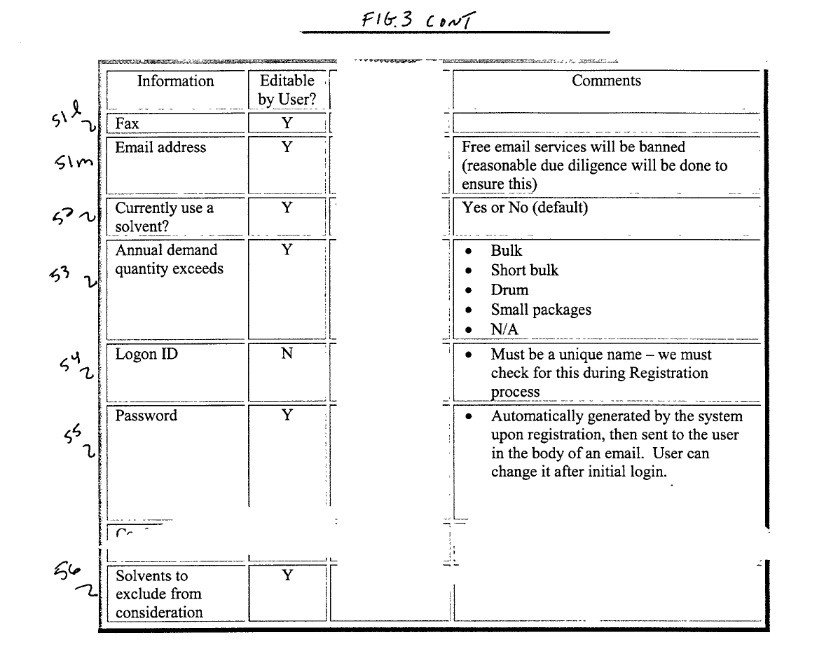

FIG. 2 is a flow diagram of a method for user registration and user input in a solvent selection project 30. In block 31, user registration information is entered via an online registration form. FIG. 3 is an example of an online registration form. Registration information can include identity information 50a-50b, company information 51a-51m, current solvents used 52, annual quantity of solvents used 53, login information 54, password information 55 and one or more solvents to exclude from a solvent project 56. The registration information directed to solvents to exclude for a solvent project is used to exclude one or more solvents when running the project software module. A mapping table can be used to include all related names of the solvent selected for exclusion.

In block 32, FIG. 2, an email is generated to notify a user of an accepted registration. In block 33 a user logs in to host 9. It will be appreciated that block 33 may not be executed if user 11 has a connection with host 9 after execution of block 32. Alternatively, if user 11 has previously registered, user input processing can be initiated by executing block 33 without executing blocks 31 and 32. User registration information entered during registration, including one or more solvents to exclude from a solvent project 56, can be edited in block 34. An email to notify the user of modifications to the user registration information is generated and forwarded to user 11, in block 35.

In block 36, user 11 determines a project using an online template for entering project input 13. For example, the template can provide a user the ability to identify a particular solvent for mandatory inclusion in a solvent model for calculation of solvent components or blends of two or three components, which would be useful for the user's defined project. The template can include help information such as a drop down list box including all solvents. In block 37, user 11 runs a project software module directed to a solvent model with the user project input. In block 38, user 11 obtains results for the solvent model.

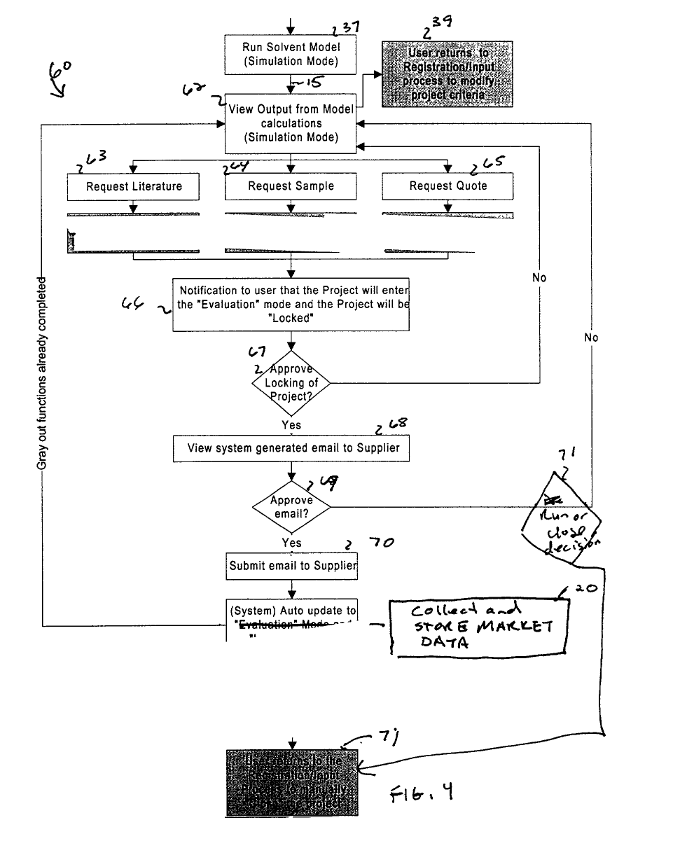

User 11 can modify a solvent project by changing project input, in block 39. In block 40, a decision is made to rerun the solvent module. If the solvent model is rerun, block 37 and block 38 are performed. After the passage of time during which the user evaluates the solvents suggested, user 11 can manually close the solvent project, in block 41. Indication of failure of the solvent project is indicated in block 42. Alternately, an indication of success of the project is indicated in block 43. FIG. 4 is a flow diagram of a method for managing user output processes 60. Program output 15 is generated from execution of proj ect software module 14 during block 37. Execution of block 37 is initiated in an “open” project mode indicating that user 11 is obtaining results and that user 11 has not yet been satisfied with program output 15. Block 37 is also initiated in an “unlocked” mode indicating that user 11 is running solvent module in block 37 or modifying input to software module, in block 39. Project output 15, from running the solvent module in block 37 can be viewed, in block 62. Preferably, for a solvent selection project, project output 15 is sorted in descending order of the degree of fit of the solvent to the user's project input criteria. Project output 15 can be sorted into a predetermined number of records for example the top five results for a type of solvent system, such as a one component solvent system, a two component blended solvent system or a three component blended solvent system. For example, an output Web page can be generated for each type of solvent system listing the predetermined number of records. A user can toggle between output Web pages of each type of solvent system.

After obtaining project output 15 by running the solvent model in block 37 that user 11 is satisfied with, user 11 enters an evaluation mode of the project and the status of the solvent project is set to a “locked” status mode. During the “locked” status mode, user 11 can request literature directed to the program output in block 63, such as solvent literature directed to the selected solvent or blend of solvents. The user can request a sample in block 64, such as a sample of the selected solvent or blend of solvents. User 11 can request a price quotation from a supplier for the solvent in block 65.

In block 66, a notification is forwarded to user 11 indicating that the project will enter the “evaluation” mode upon transmittal of a literature, sample, or price quotation request and the project will be locked. In block 67, user 11 determines approval for locking of the project. If user 11 is not satisfied with the results of the project, or chooses not to have user's request(s) forwarded, user 11 can return to modify a solvent project by changing user input criteria, in block 39. If the locking of the project is approved and a price quotation, sample, or literature was requested in block 65, an email is generated to a registered supplier 22 in block 68. In block 69, a determination is made for acceptance of the email to the supplier. If the email is approved, the email to the supplier is submitted to registered supplier 22 in block 70. After completion of the project, such as the user making a purchase or no longer being interested in making a purchase, project output is forwarded to collect and store market data module 20. In block 71, the user returns to registration module 12 to enter a “closed” status of the project. If the email to the supplier is not approved by the user, a decision is made to rerun the project or to close the project in block 72. If the project is rerun, block 62 is executed to allow the user to make a subsequent quote request in block 65. If the project is closed, block 71 is executed.

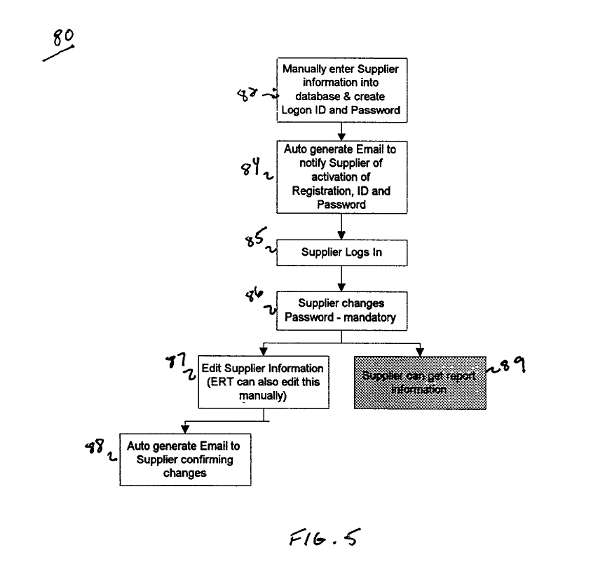

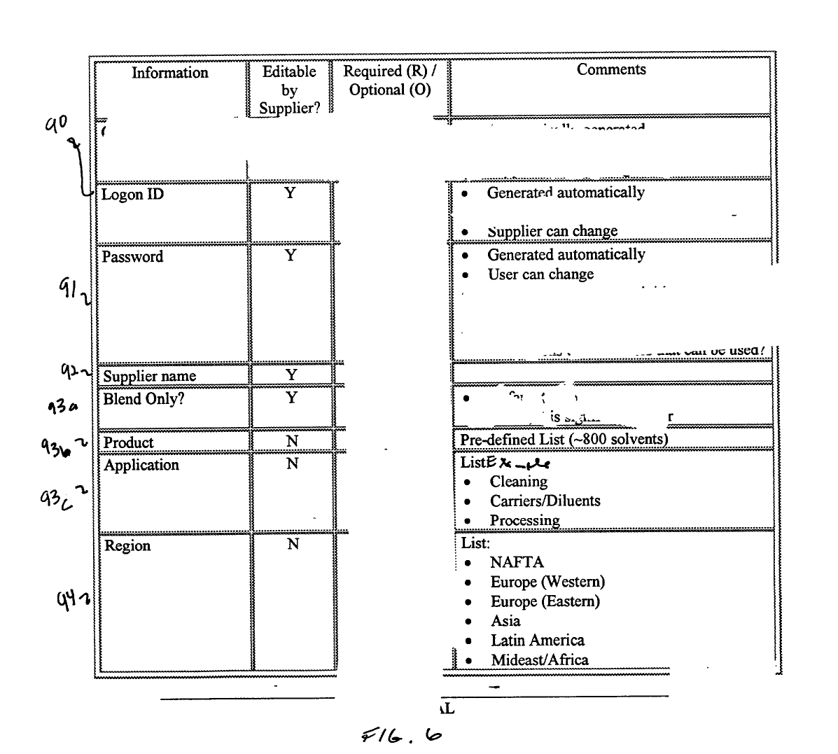

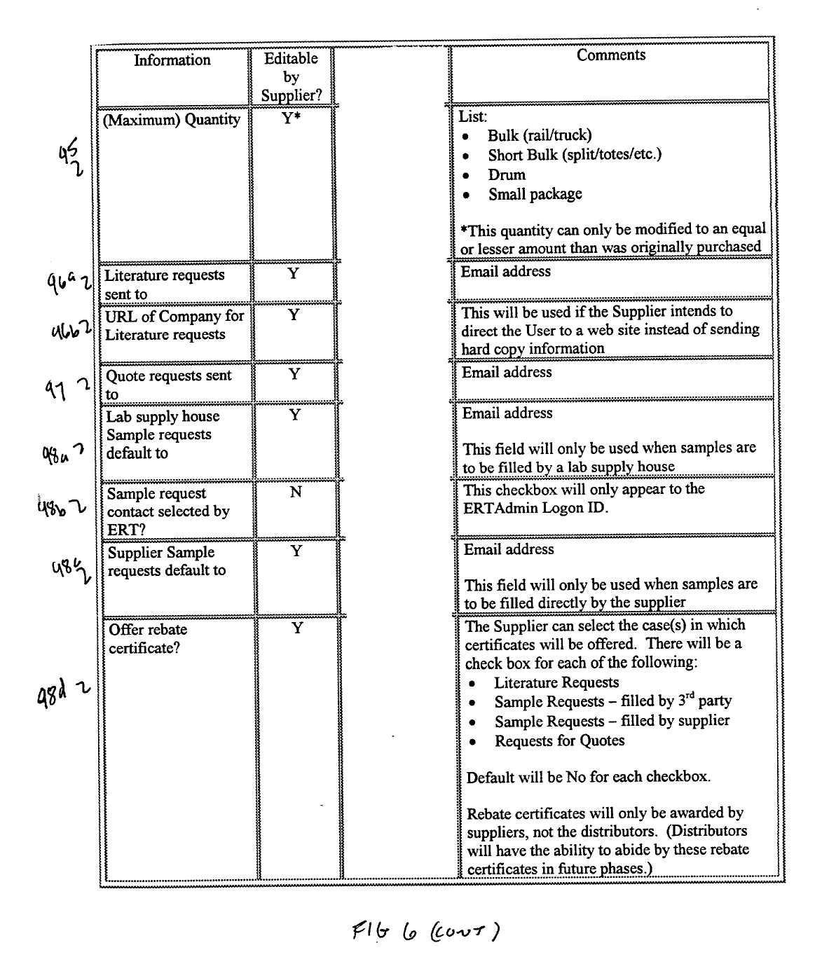

FIG. 5 is a flow diagram of a method for supplier registration and supplier receipt of market trend data 80. In block 82, supplier information is entered via an online supplier registration form. FIG. 6 is an example of an online supplier registration form. Supplier registration information can include login information 90, password information 91, supplier name 92, type of products and applications supplied 93a-c, supplied region 94,/type of quantities supplied 95, literature request information 96a-b, quote request information 97 and sample request information 98a-98d.

In block 84, an email is generated to the supplier to notify the supplier of activation of the supplier's registration, supplier identification and password. In block 85, the supplier logs into host 9. In block 86, the password can be changed by the supplier. In block 87, the user can edit supplier information. An email is generated confirming the changes to the supplier information, in block 88. In block 89, the supplier obtains market and trend data. The market and trend data can be in the form of a report. Example reports are as follows:

1. Replaced Solvents as a graph of information to allows subscribers to view the users, by number and percent of total, who have accessed project software module 14 for solvent selection to replace the solvent in the supplier's channel subscription. This data can be broken down by reason (performance, cost, environmental or regulatory).

2. Excluded Solvents as a graph of information to allows suppliers to view the users, by number and percent of total, that have requested that he supplier's solvent be excluded from consideration when using the solvent selection model.

3. Included Solvents as a graph of information to allow suppliers to view the users, by number and percent of total, that have requested that the supplier's solvent be included in blend formulations when using the solvent selection model.

4. Sample Requests for showing 24-month rolling totals of samples ordered by users. This information also reflects positive acceptance of the supplier's product by the user community

5. Request for Quotes (RFQ) for showing 24-month rolling totals of requested quotes for solvents by users.

6. Certificate Status for showing the status of rebate certificates offered to users. “Open” certificates reflect projects where the solvent is still in the testing and evaluation phase. “Closed” certificates reflect projects where the solvent has been eliminated from consideration, due to either the selection of an alternative solvent or the termination of the active project for other reasons. “Redeemed” certificates reflect the successful implementation of the supplier's solvent in the user's industrial application, and as such can be used to assist the supplier in quantifying the benefits of continued channel subscription, as described below.

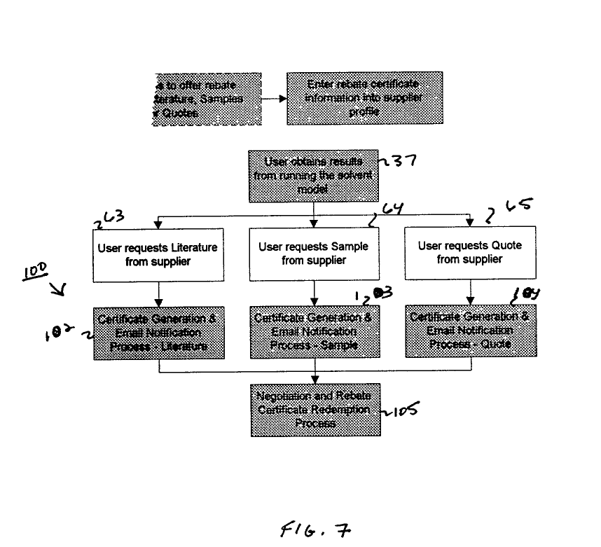

FIG. 7 is a flow diagram of a method for rewarding rebate certificates 100. After each of blocks 63, 64 and 65 are performed, respective blocks 102, 103 and 104 are performed for certificate generation and notification of the generated certificate. In block 105, the issued rebate certificate can be redeemed and negotiated related to the cost of purchase of a product at a supplier or at a central location supply house servicing products for a plurality of suppliers.

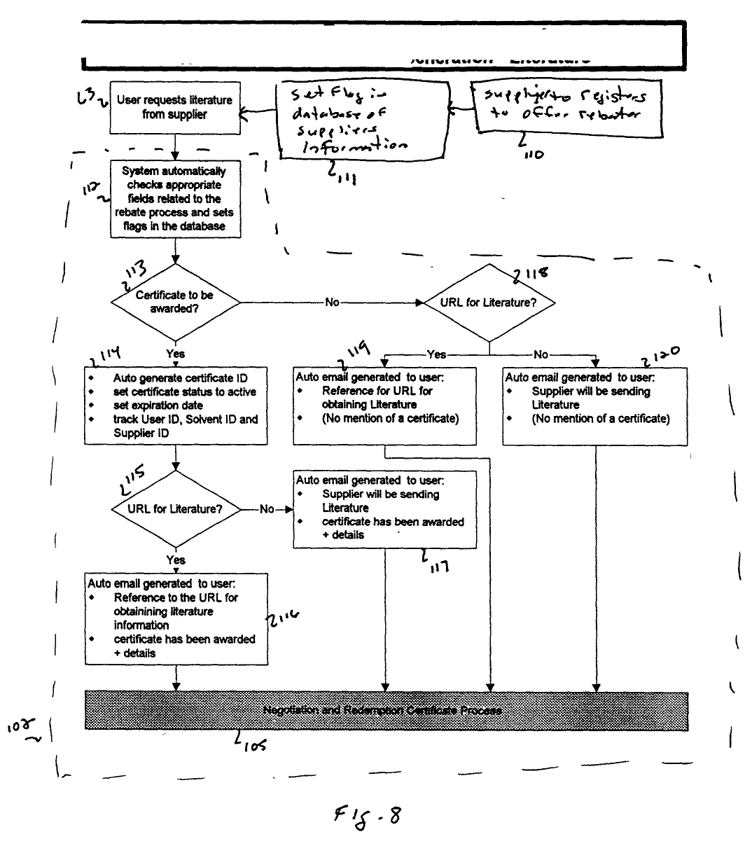

FIG. 8 is a flow diagram of a method for rewarding a rebate certificate after a literature request is performed in block 102 and processing the literature request. In block 110, a supplier registers to offer rebate certificates for requests for literature of a product. A flag is set in a database of the suppliers requested information in block 111. Block 110 can be performed before a literature request is performed by a user in block 63. In block 112, a check is made of the appropriate fields of a rebate database.

In block 113, a determination is made to see if the rebate certificate should be awarded. In block 112, flags can be set in a rebate database for indicating the status of a users request. For example, the following flags can be used in the rebate database.

User ID

Solvent ID

Supplier ID

A certificate status flag can be used during the check to determine if a rebate certificate has ever been awarded to the user for a particular solvent.

In block 113, a decision is made for awarding a certificate. If a certificate is to be awarded, block 114 is performed for generating a rebate certificate. The following flags can be used to generate the rebate certificate.

Certificate status (active, redeemed, inactive/expired)

Certificate expiration date

User purchase order number for redeemed certificate

Supplier order number for redeemed certificate

Quantity order

Quantity unit of measure (pounds, kilograms, gallons, liters-can have automatic

conversion routine to be used in calculations)

Price

Date redeemed or expired

During block 114, the rebate certificate is assigned a certificate ID. The certificate status flag is set to active. A value is determined for an expiration date of the rebate certificate. The information from the flags for the user ID, solvent and supplier ID can be added to the rebate certificate. In block 115, a decision is made if a universal resource locator exists (URL). If a URL exists, an email is generated to the user indicating the references for obtaining literature information, in block 116. The email can include the rebate certificate and details on redemption of the rebate certificate. If a URL does not exist, block 117 is performed to generate an email to the user indicating that the supplier will send literature to the user. The email can include the rebate certificate and details on redemption of the rebate certificate.

If a certificate is not to be awarded, in block 118 a decision is made if a URL exists. If a URL exists, an email is generated to the user indicating URL references for obtaining literature information, in block 119. If a URL does not exist, block 120 is performed to generate an email to the user indicating that the supplier will send literature to the user

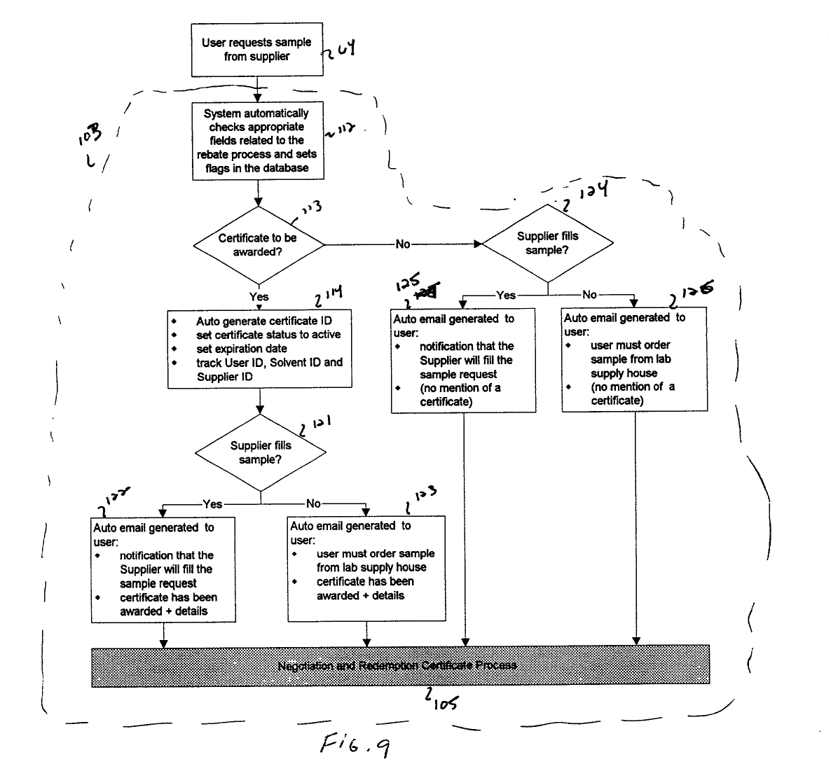

FIG. 9 is a flow diagram of a method for rewarding a rebate certificate after a sample request is performed in block 103 and processing of the sample request. Blocks 112, 113 and 114 are performed as described above. In block 121, a decision is made for a supplier to fill a sample request. If the supplier will fill the sample request, an email is generated to the user, including the rebate certificate and indicating that the supplier will fill the sample request, in block 122. If the supplier will not fill the sample request, an email is generated to the user including the rebate certificate and indicating that the sample request can be filled at a central lab supply house, in block 123.

If a certificate is not to be awarded, block 124 is performed and a decision is made for a supplier to fill a sample request. If the supplier will fill the sample request, an email is generated to the user, including the rebate certificate indicating that the supplier will fill the sample request, in block 125. If the supplier will not fill the sample request, an email is generated to the user including the rebate certificate and indicating that the sample request can be filled at a central lab supply house in block 126.

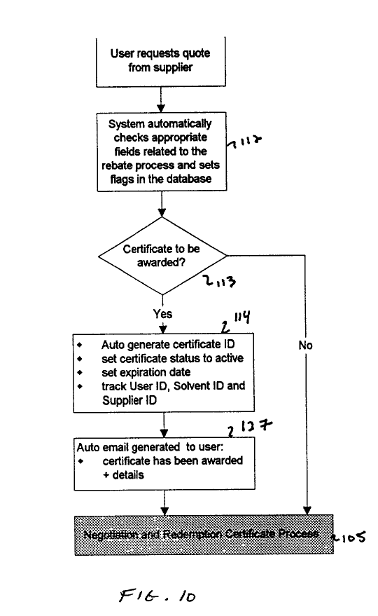

FIG. 10 is a flow diagram of a method for rewarding a rebate certificate after a request for a price quotation is performed in block 104. Blocks 112, 113 and 114 are performed as described above. In block 127, an email is generated including the rebate certificate and a quote from the supplier.

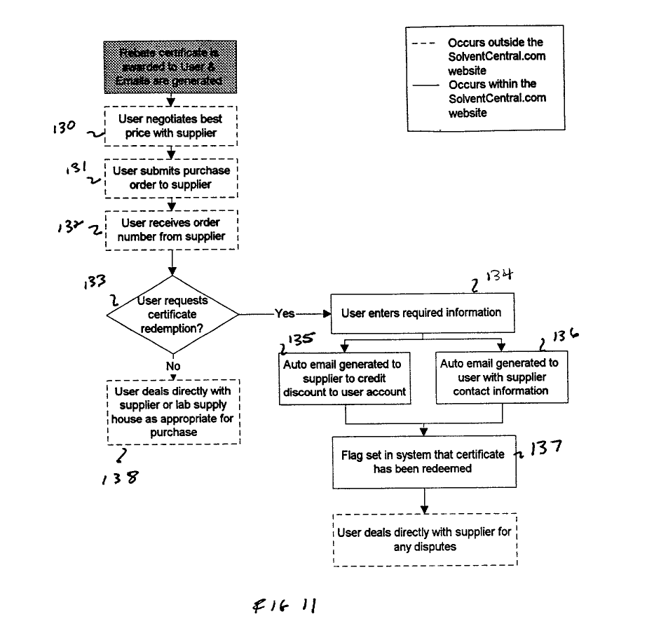

FIG. 11 is a flow diagram of negotiation and rebate certificate redemption. In block 130, user 11 negotiates a best price with a supplier. A purchase order is submitted from user 11 to supplier, in block 131. In block 132, a user receives an order number from the supplier. Blocks 130-132 are optional and can be performed by user 11 outside of system 10.

In block 133, a user logs into host 9 and a decision is made for the user requesting certificate redemption. If the user requests certificate redemption, the user can be presented with a record and a request that the user fill in information such as a purchase order number, a supplier order number, quantity of solvent ordered and price. In block 135, an email is sent to the supplier and the supplier determines a discount to be applied to the users account for crediting the rebate certificate. In block 136, an email can be generated to the user informing the user of the discount and providing a supplier contact for mediating any disputes of the supplied discount. In block 137, the certificate status flag is set indicating that the rebate certificate was redeemed. If the user does not request certificate redemption, a user negotiates directly with a supplier or lab supply house as appropriate for a users purchase of a selected product. It is to be understood that the above-described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

I claim:

1. A system for generating project solution information directed to products of one or more suppliers and market research and user trend data comprising:
user input means for entering user registration information and project input criteria;
software project processing means for processing said project input criteria to generate said project solution information;
collections means for collecting said user registration information, project input criteria and said project solution information; and
sorting means for sorting said collected user registration information, project input criteria and project solution information into said market research and user trend data.

2. The system of claim 1 further comprising:
supplier input means for entering supplier registration information: and
supplier registration means for registering a supplier based on said supplier registration information, as a registered supplier,
wherein said registered supplier has access to said market research and user trend data.

3. The system of claim 2 further comprising:
means for forwarding said user registration information and project solution information to said registered supplier.

4. The system of claim 1 further comprising:
means for generating a rebate certificate based on said project solution information.

5. The system of claim 1 wherein said project input criteria is a request for information related to products selected from the group consisting of chemical, electronics, automotive, transportation, aerospace, building, construction, architecture, consumer product information, medical, pharmaceutical, farming and agricultural products.

6. The system of claim 1 wherein said project input criteria is a request for information related to products selected from the group consisting of chemical solvents, absorbents, additives, adhesives, aerosols, biocides, catalysts, ceramics, coatings, cosmetics, disinfectants, fabrics, fibers, flame retardants, flavors, formulations, fragrances, gases, heat transfer fluids, industrial gases, inks, insulations, lubricants, metal finishings, metals, nutraceuticals, papers, pesticides, pigments, plasticizers, plastic additives, plasticizers, pulps, papers, resins, sealants, surfactants, textiles, toiletries, vitamins, waste disposals and waxes.

7. The system of claim 6 wherein said project input criteria is a solvent project solution.

8. The system of claim 7 wherein said project input criteria is one or more solvent processing parameters selected from processing parameters such as density, vapor pressure, evaporation rate, boiling point and flash point.

9. The system of claim 7 wherein said software project processing means determine a best match of a solvent or a solvent blend with said input criteria.

10. The system of claim 7 wherein said project input criteria is one or more solvents to include in said project solution information.

11. The system of claim 7 wherein said project input criteria is one or more solvents to exclude in said project solution information.

12. The system of claim 1 wherein said user input means communicates to said software project processing means over the Internet.

13. The system of claim 1, wherein said collecting means comprises;
means for generating a database for said user registration information, means for generating a database for said project input criteria; and
means for generating a database for said project solution information.

14. The system of claim 1 wherein said user input means comprises:
an online registration form for entering user information and project input criteria.

15. A method for generating project solution information directed to products of one or more suppliers and market research and user trend data comprising the steps of:
inputting user registration information and project input criteria;
processing said project input criteria to generate said project solution information;
collecting said user registration information, said project input criteria and said project solution information, and;
sorting said collected user registration information, project input criteria and project solution information into said market research and user trend data.

16. The method of claim 15 further comprising the steps of:
inputting supplier registration information; and
registering a supplier based on said supplier registration information, as a registered supplier, wherein said registered supplier has access to said market research and user trend data.

17. The method of claim 16 further comprising the step of:
forwarding said user registration information and project solution information to said registered supplier.

18. The method of claim 15 further comprising the step of:
generating a rebate certificate based on said project solution information.

19. The system of claim 1 wherein said project input criteria is a request for information related to products selected from the group consisting of chemical, electronics, automotive, transportation, aerospace, building, construction, architecture, consumer product information, medical, pharmaceutical, farming and agricultural products.

20. The method of claim 15 wherein said project input criteria is a request for information related to products selected from the group consisting of chemical solvents, absorbents, additives, adhesives, aerosols, biocides, catalysts, ceramics, coatings, cosmetics, disinfectants, fabrics, fibers, flame retardants, flavors, formulations, fragrances, gases, heat transfer fluids, industrial gases, inks, insulations, lubricants, metal finishings, metals, nutraceuticals, papers, pesticides, pigments, plasticizers, plastic additives, plasticizers, pulps, papers, resins, sealants, surfactants, textiles, toiletries, vitamins, waste disposals and waxes.

21. The method of claim 20 wherein said project input criteria is a solvent project solution.

22. The system of claim 21 wherein said project input criteria is one or more solvent processing parameters selected from processing parameters such as density, vapor pressure, evaporation and flash point.

23. The system of claim 21 wherein said software project processing means determine a best match of a solvent or a solvent blend with said input criteria.

24. The system of claim 21 wherein said processing input criteria is one or more solvents to include in said project solution information.

25. The system of claim 21 wherein said processing input criteria is one or more solvents to exclude in said project solution information.

26. The method of claim 15, wherein said collating step comprises the steps of;
generating a database for said user registration information, generating a database for said project input criteria; and
generating a database for said project solution information.

27. The method of claim 15, wherein said user registration and project input criteria is entered in an online registration form.

28. A method for generating solvent information from one or more suppliers and market research and user trend data of users requesting said solvent information comprising the steps of:
inputting user registration information;
inputting solvent input criteria;
processing said solvent input criteria to generate said solvent information for one or more suppliers;
collecting said user registration information, said solvent input criteria and said solvent information;
sorting said user registration information, said solvent input criteria and said solvent information into said market research and user trend data.

29. The method of claim 28 wherein said user registration information is inputted into an online registration form, said user registration information including user identity information, company information, current solvents used information, annual quantity of solvents used information, and login buyer information.

30. The method of claim 29 wherein said user registration information further comprises one or more solvents to exclude.

31. The method of claim 28 further comprising the step of:
mapping respective said one or more solvents to exclude to related names of solvents.

32. The method of claim 28 wherein said processing step includes processing said input criteria with a solvent model.

33. The method of claim 28 wherein solvent input criteria is inputted into an online template, said solvent input criteria including one or more criteria selected for the group consisting of one or more solvents to include in said solvent model, processing parameters such as density, vapor pressure, evaporation and flash point.

34. The method of claim 28 further comprising the steps of:
inputting second input criteria; and
repeating said processing steps with said second input criteria.

35. The method of claim 28 further comprising the steps of:
viewing said generated solvent information for one or more suppliers.

36. The method of claim 35 wherein said viewing step is performed by sorting said generated solvent information in descending order of the degree of fit of said generated solvent information to said solvent input criteria.

37. The method of claim 35 wherein after said viewing step, further comprising the step of:
requesting literature directed to said generated solvent information.

38. The method of claim 28 further comprising the step of:
requesting a rebate certificate directed to said generated solvent information;
generating an email to a user including said rebate certificate and a reference to a universal resource locator for said literature or an indication a supplier will send said literature.

39. The method of claim 35 wherein after said viewing step further comprising the step of:
requesting a rebate certificate directed to said generated solvent information.

40. The method of claim 39 further comprising the step of:
generating an email to a user including said rebate certificate and a reference that a supplier will fill a sample corresponding to said rebate certificate or that a supply house will fill a sample corresponding to said rebate certificate.

41. The method of claim 28 further comprising the step of:
requesting a rebate certificate directed to said generated solvent information; generating an email to a user including said rebate certificate.

42. The method of claim 35 wherein after said viewing step further comprising the step of:
requesting a price quotation for said generated solvent information.

43. The method of claim 42 wherein said requesting step comprises sending an email to suppliers of said generated solvent information.

44. The method of claim 28 further comprising the step of:
inputting supplier registration information; and
registering a supplier based on said supplier registration information, as a registered supplier;
wherein said registered supplier have access to said market research and user trend data.

45. The method of claim 44 wherein said supplier information is inputted into a online registration form for sending supplier registration information including one or more of password information, supplier name, type of products and applications supplied, supplied region, type of quantities supplied, literature request information, quote request information and sample request information.

46. The method of claim 28 wherein said market research and user trend data is in a form of a report including information selected from menu of the group consisting of replaced solvents, excluded solvents, included solvents, rebate certificate requests, requests for quotes and status of rebate certificates.
